(19) United States
(12) Patent Application Publication
(10) Pub. No.: US 2024/0168299 A1
(43) Pub. Date: May 23, 2024

(54) KALEIDOSCOPIC WAVEGUIDE AS SMALL-FORM-FACTOR PUPIL EXPANDER

(71) Applicant: Meta Platforms Technologies, LLC, Menlo Park, CA (US)

(72) Inventors: Xingzhou TU, Redmond, WA (US); Wai Sze Tiffany LAM, Lynnwood, WA (US); Wanli CHI, Sammamish, WA (US); Miaomiao XU, Redmond, WA (US)

(21) Appl. No.: 18/518,357

(22) Filed: Nov. 22, 2023

Related U.S. Application Data
(60) Provisional application No. 63/384,827, filed on Nov. 23, 2022.

(51) Int. Cl. G02B 27/01

(52) U.S. Cl. CPC G02B 27/0172; G02B 2027/0123

(57) ABSTRACT

A waveguide display includes a first waveguide assembly and a second waveguide assembly. The first waveguide assembly includes a first waveguide extending in a first direction, a first input coupler configured to couple display light into the first waveguide such that the display light is reflected through total internal reflection by three or more surfaces of the first waveguide that are parallel to the first direction to propagate within the first waveguide in the first direction, and a first output coupler configured to couple the display light out of the first waveguide at a first plurality of locations along the first direction. The second waveguide assembly is configured to deflect, at a second plurality of locations along a second direction different from the first direction, the display light from the first waveguide towards an eyebox of the waveguide display.

### CROSS-REFERENCE TO RELATED APPLICATIONS

This application claims the benefit of and priority to U.S. Provisional Application No. 63/384,827, filed Nov. 23, 2022, entitled “KALEIDOSCOPIC WAVEGUIDE AS SMALL-FORM-FACTOR PUPIL EXPANDER,” which is herein incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 12-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings or volume Bragg gratings. Light from the surrounding environment may pass through a see-through region of the waveguide and reach the user's eyes as well.

### SUMMARY

This disclosure relates generally to near-eye display systems. More specifically, techniques disclosed herein relates to waveguide-based near-eye display systems including kaleidoscopic waveguides as small-form-factor pupil expanders. Various inventive embodiments are described herein, including devices, components, systems, assemblies, modules, subsystems, and the like.

According to certain embodiments, a waveguide display may include a first waveguide assembly and a second waveguide assembly. The first waveguide assembly may include a first waveguide extending in a first direction, a first input coupler configured to couple display light into the first waveguide such that the display light is reflected through total internal reflection by three or more surfaces of the first waveguide that are parallel to the first direction to propagate within the first waveguide in the first direction, and a first output coupler configured to couple the display light out of the first waveguide at a first plurality of locations along the first direction. The second waveguide assembly may be configured to deflect, at a second plurality of locations along a second direction different from the first direction, the display light from the first waveguide towards an eyebox of the waveguide display.

According to certain embodiments, a near-eye display system may include an image source configured to emit display light of images, display optics configured to project the display light, a first pupil expander extending in a first direction, and a second pupil expander. The first pupil expander may be configured to reflect the display light from the display optics through total internal reflection at three or more surfaces that are parallel to the first direction to guide the display light in the first direction, and couple the display light out of the first pupil expander at a first plurality of locations along the first direction. The second pupil expander may be configured to split the display light from each location of the first plurality of locations of the first pupil expander at a second plurality of locations along a second direction that is different from the first direction.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6 illustrates an example of a waveguide display including two waveguides for two-dimensional (2D) pupil expansion.

FIG. 7 illustrates an example of a waveguide display including two waveguide assemblies for pupil expansion and a scanning mirror for 2D field of view (FOV) expansion.

FIG. 8 illustrates an example of a waveguide display including one or more curved waveguides for pupil expansion and a scanning mirror for 2D FOV expansion.

FIGS. 9A and 9B illustrate an example of a kaleidoscopic waveguide for pupil expansion and 2D FOV expansion in a waveguide display according to certain embodiments.

FIG. 10A illustrates light reflections by four surfaces of an example of a kaleidoscopic waveguide according to certain embodiments.

FIG. 10B illustrates wave vectors of display light being reflected by the four surfaces of the kaleidoscopic waveguide of FIG. 10A through total internal reflection according to certain embodiments.

FIG. 11A illustrates an example of a kaleidoscopic waveguide including an embedded thick grating for coupling display light out of the kaleidoscopic waveguide according to certain embodiments.

FIG. 11B illustrates an example of a kaleidoscopic waveguide including a pair of thin gratings for coupling display light into and out of the kaleidoscopic waveguide according to certain embodiments.

FIG. 11C illustrates an example of a kaleidoscopic waveguide including a micro-mirror array for coupling display light out of the kaleidoscopic waveguide according to certain embodiments.

FIG. 11D illustrates an example of a kaleidoscopic waveguide including transflective mirrors for coupling display light out of the kaleidoscopic waveguide according to certain embodiments.

FIGS. 12A-12D illustrate examples of kaleidoscopic waveguides having different cross-sectional shapes according to certain embodiments.

FIGS. 13A and 13B illustrate an example of a waveguide display including a kaleidoscopic waveguide for pupil expansion and 2D FOV expansion according to certain embodiments.

FIG. 14 illustrates an example of a geometrical waveguide display including a kaleidoscopic geometrical waveguide for pupil expansion and 2-D FOV expansion according to certain embodiments.

FIG. 15 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display systems. More specifically, techniques disclosed herein relates to waveguide-based near-eye display systems including kaleidoscopic waveguides as small-form-factor pupil expanders. Various inventive embodiments are described herein, including devices, components, systems, modules, assemblies, subsystems, and the like.

An optical see-through near-eye display system for augmented reality or mixed reality applications generally includes an image source (e.g., a micro-display), an optical combiner, and an eyepiece. The optical combiner may include, for example, a flat beam splitter, a curved or freeform surface with a beam-splitting coating, a diffractive (e.g., holographic) waveguide, or a geometrical waveguide. Optical combiners made of flat beam splitters or freeform surfaces may have high image quality but may have large sizes. Waveguide displays using, for example, diffractive couplers (e.g., volume Bragg gratings or surface-relief gratings) or transflective mirrors, can be made thin and compact. In waveguide displays, multiple waveguides and/or couplers may be used to replicate the exit pupil, thereby increasing the size of the eyebox so that the user's eyes may be able to view the displayed image even if the user's eyes move within a large area. To achieve a large field of view (FOV), a waveguide display using diffractive couplers or transflective mirrors may generally need to have a large form factor (e.g., a large area).

In some implementations, to reduce the size of a waveguide display, a long bar-shaped waveguide may be used to split the input display light into a one-dimensional (1D) array of light beams along one direction (e.g., the length direction of the bar-shaped waveguide), thereby replicating the pupil in one dimension. A larger waveguide may receive the 1D array of light beams and split each light beam into an array of light beams along another direction, thereby replicating the pupil in another dimension. Therefore, two-dimensional (2D) pupil replication may be achieved by the combination of the bar-shaped waveguide and the larger waveguide to expand the eyebox. The bar-shaped waveguide may have a relatively small FOV in at least one dimension (e.g., a line FOV with about 0° FOV in a direction perpendicular to the length direction of the bar-shaped waveguide) to avoid reflections by sidewalls that may result in optical artifacts such as ghost images. A scanning mirror (e.g., a galvanometer mirror or microelectromechanical system (MEMS) mirrors) may be used to scan the array of light beams from the bar-shaped waveguide to increase the FOV in the dimension perpendicular to the length direction of the bar-shaped waveguide, to achieve a larger 2D field of view. Using the scanning mirror may increase the size, complexity, and cost, and reduce the reliability of the waveguide display.

According to certain embodiments, a kaleidoscopic waveguide may be used to replicate the pupil of a waveguide display in one dimension and also increase the FOV of the waveguide display, and thus a scanning mirror may not be used in the waveguide display. The kaleidoscopic waveguide may have a similar shape and size as the bar-shaped waveguides in waveguide displays that use scanning mirrors, but may be configured to guide the display light coupled into the kaleidoscopic waveguide in different manners. For example, display light coupled into a kaleidoscopic waveguide may be reflected by more than two surfaces of the kaleidoscopic waveguide, such as four surfaces of a kaleidoscopic waveguide having a rectangular cross-section, thereby creating multiple images of different parity in each round trip (e.g., including four reflections at the four surfaces due to total internal reflection). The kaleidoscopic waveguide can be configured such that the reflections by sidewalls may not cause optical artifacts or may cause tolerable optical artifacts, and thus the FOV of the kaleidoscopic waveguide can be large in two dimensions. One or more of the multiple images covering a large 2D FOV may be coupled out of the kaleidoscopic waveguide by, for example, a grating or transflective mirrors, through one surface of the kaleidoscopic waveguide towards a second waveguide. The second waveguide may replicate the exit pupil in another dimension to achieve 2D pupil expansion. In this way, a waveguide display including a kaleidoscopic waveguide may have a small form factor and no moving parts (e.g., a scanning mirror), and may be able to achieve 2D pupil expansion and a large 2D FOV.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

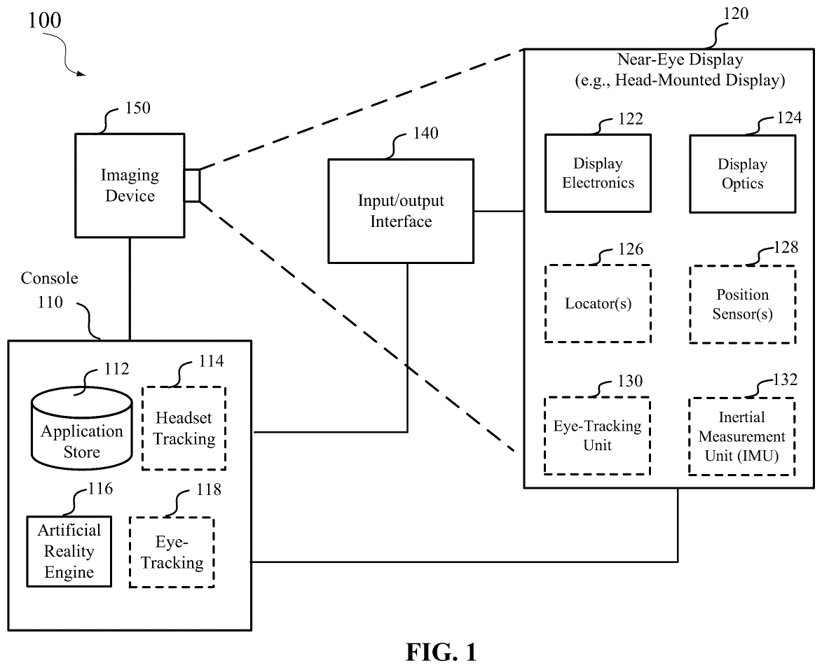

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

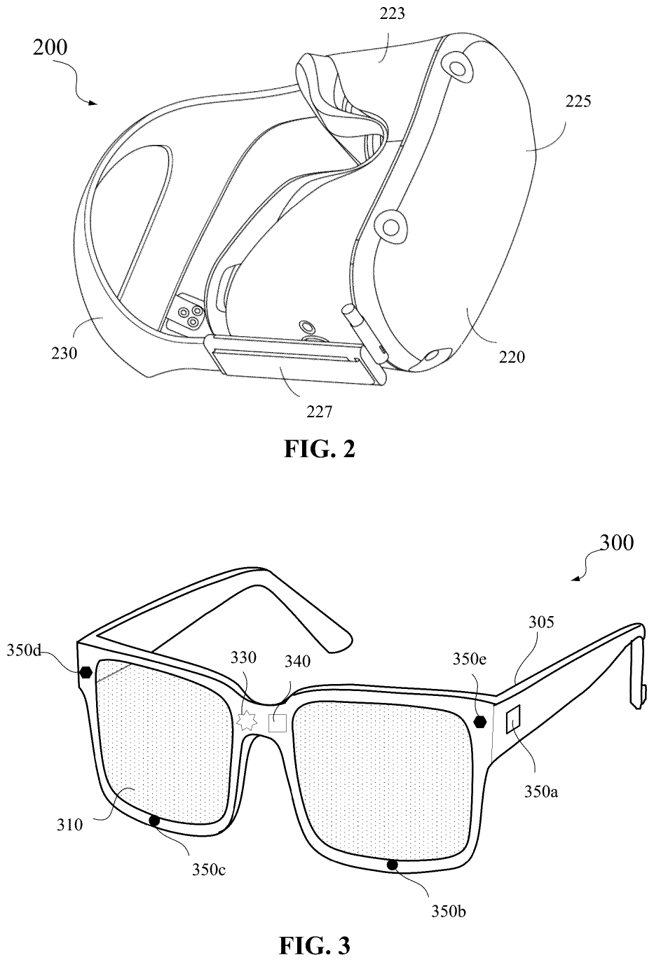

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

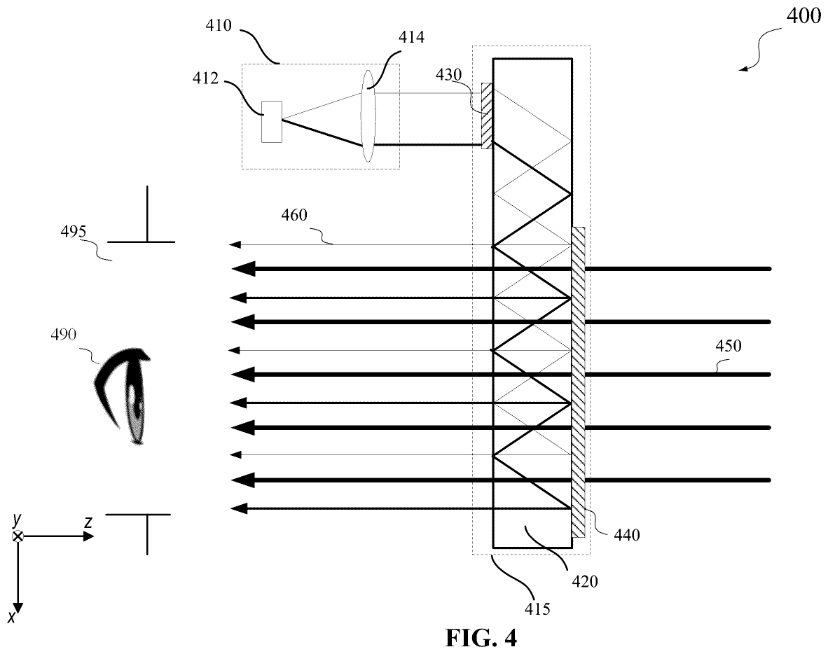

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 12 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

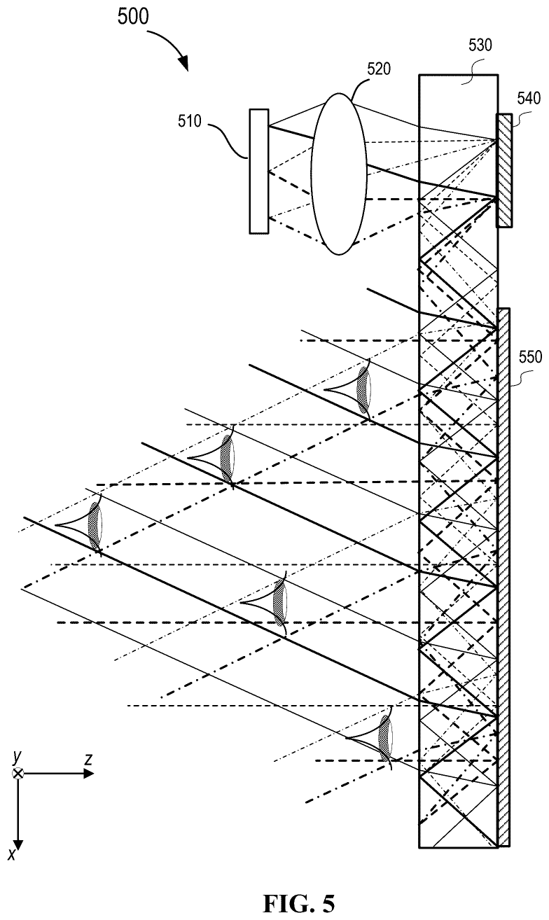

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. In other words, the user's eye may convert angular information in the eyebox or exit pupil (e.g., corresponding to a Fourier plane) to spatial information in images form on the retina. FIG. 5 shows that the image of the image source is visible by the user's eye even if the user's eye moves to different locations in the eyebox.

As described above, in a waveguide-based near-eye display system, light of projected images may be coupled into a waveguide (e.g., a transparent substrate), propagate within the waveguide through total internal reflection, and be coupled out of the waveguide at multiple locations to replicate the exit pupil and expand the eyebox. Multiple waveguides and/or multiple couplers (e.g., gratings or transflective mirrors) may be used to replicate the exit pupil in two dimensions to fill a large eyebox (e.g., 40×40 mm² or larger) with a 2D array of pupils (e.g., 2×2 mm²), thereby expanding the eyebox such that the user's eyes can view the displayed image even if the user's eyes move within a large area. For example, two or more gratings may be used to expand the display light in two dimensions or along two axes. The two gratings may have different grating parameters, such that one grating may be used to replicate the exit pupil in one direction and the other grating may be used to replicate the exit pupil in another direction. In such waveguide display systems, to achieve a large FOV, the two or more gratings may need to be large, and thus the waveguide display may have a large form factor (e.g., a large area). In some implementations, to reduce the size the waveguide displays, a long bar-shaped waveguide may be used to split the input display light into a one-dimensional (1D) array of light beams along one direction (e.g., the length direction of the bar-shaped waveguide), thereby replicating the pupil in one dimension. A larger waveguide may receive the 1D array of light beams and split each light beam into an array of light beams along another direction, thereby replicating the pupil in another dimension. Therefore, two-dimensional (2D) pupil replication may be achieved by the combination of the bar-shaped waveguide and the larger waveguide to expand the eyebox. The long bar-shaped waveguide and the larger waveguide may be stacked to form a three-dimensional structure and reduce the form factor (e.g., the total area) of the waveguide display.

FIG. 6 illustrates an example of a waveguide display 600 including two waveguides for two-dimensional (2D) pupil expansion. In the illustrated example, waveguide display 600 may include a first assembly 610 that may include a light source 612 for generating display light, a projector 614 for projecting the display light onto an input coupler 617 for a first waveguide 616. Input coupler 617 may couple the display light into first waveguide 616 such that the display light may be guided by first waveguide 616 through total internal reflection to propagate within first waveguide 616 in approximately the −x direction. An output coupler 618 for first waveguide 616 may couple a portion of the display light guided by first waveguide 616 out of first waveguide 616, each time the display light is incident on output coupler 618. Therefore, first waveguide 616 may split the display light into multiple display light beams 640 that are output at multiple locations along a first direction (e.g., the x direction). The multiple display light beams 640 generated by first assembly 610 may be coupled into a second waveguide 620 by an input coupler 650 such that display light beams 640 may be guided by second waveguide 620 to propagate along approximately the −y direction. Display light guided by second waveguide 620 may be coupled out of second waveguide 620 towards user's eye 690 (or an eyebox) each time the display light is incident on an output coupler 660. Therefore, second waveguide 620 may split each display light beam 640 into multiple display light beams that are output at multiple locations along a second direction (e.g., the y direction).

Light source 612 may include, for example, one or more laser diodes, light emitting diodes (LEDs), micro-LEDs, resonant-cavity LEDs (RC-LEDs), vertical cavity surface emitting lasers (VCSELs), organic LEDs (OLEDs), micro-OLEDs, liquid crystal display (LCD) cells, and the like. Light source 612 may emit visible light of multiple colors, such as red, green, and blue light. In some embodiments, light source 612 may include one or more rows or one or more columns of light emitters of different colors, such as multiple rows of red light emitters, multiple rows of green light emitters, and multiple rows of blue light emitters. In some embodiments, light source 612 may include a 2D array of light emitters.

Projector 614 may include one or more optical components that can condition the display light from light source 612. Conditioning display light from light source 612 may include, for example, expanding, collimating, converging, diverging, or a combination thereof. In some embodiments, the optical power of projector 614 may be adjusted by, for example, mechanically translating a projection lens relative to light source 612, or using a tunable liquid crystal lens that can adjust the optical power under the control of a controller (not shown in FIG. 6). The one or more optical components may include, for example, lenses, mirrors, apertures, gratings, prisms, or a combination thereof.

Input coupler 617 may include, for example, a grating, a prism or wedge, or a reflecting surface, and may couple the display light from projector 614 into first waveguide 616 through diffraction, refraction, or reflection. First waveguide 616 may be characterized by a shape of long bar, and may have a relatively small form factor. In one example, first waveguide 616 may be approximately 50 mm or longer along the x dimension, about 5-10 mm (e.g., about 6 mm) along the y dimension, and about 0.3-1 mm along the z dimension. First waveguide 616 may be configured to expand the display light (e.g., via pupil replication) in one dimension (e.g., the x direction) through total internal reflection by surfaces of first waveguide 616 and output coupling by output coupler 618 as described above with respect to, for example, FIGS. 4 and 5. Output coupler 618 may include, for example, a surface-relief grating (SRG), a holographic grating (e.g., a volume Bragg grating (VBG)), a polarization volume hologram (PVH), partial reflectors (e.g., transflective mirrors that can partially reflect incident light and partially transmit incident light), a micro-mirror array, and the like.

Second waveguide 620 may have a larger form factor, such as having a width greater than about 40 mm, 50 mm, 60 mm, or larger. Second waveguide 620 may receive display light beams 640 at input coupler 650, which may couple the display light into second waveguide 620. Input coupler 650 may include, for example, a surface-relief grating, a holographic grating, a PVH, and the like. Second waveguide 620 may guide the received display light to output coupler 660. Output coupler 660 may include, for example, a holographic grating (e.g., VBGs) or an array of transflective mirrors, and may split and couple each display light beam 640 out of second waveguide 620 towards user's eye 690 (or an eyebox) at multiple locations along approximately the y direction, thereby replicating the exit pupil along the y direction.

As such, the exit pupil may be replicated along approximately the x direction by first waveguide 616 and may be further replicated along approximately the y direction by second waveguide 620 to achieve 2D pupil expansion. In some embodiments, the replicated exit pupils may partially overlap in the eyebox. The pupil expansion may occur in two directions that may or may not be orthogonal. The replicated pupils may fill an eyebox (e.g., ≥10-40 mm or larger in diameter or width), such that the user's eye 690 may view the displayed content even if it moves within the eyebox.

A bar-shaped waveguide (e.g., first waveguide 616) may reduce the form factor of the waveguide display, but may have a relatively small FOV in at least one dimension (e.g., in the y direction in the example shown in FIG. 6). In some implementations, a scanning mirror (e.g., a galvanometer mirror or microelectromechanical system (MEMS) mirrors) may be used to scan the array of light beams from the bar-shaped waveguide in one direction (e.g., the y direction) to increase the FOV in the direction and achieve a large 2D field of view.

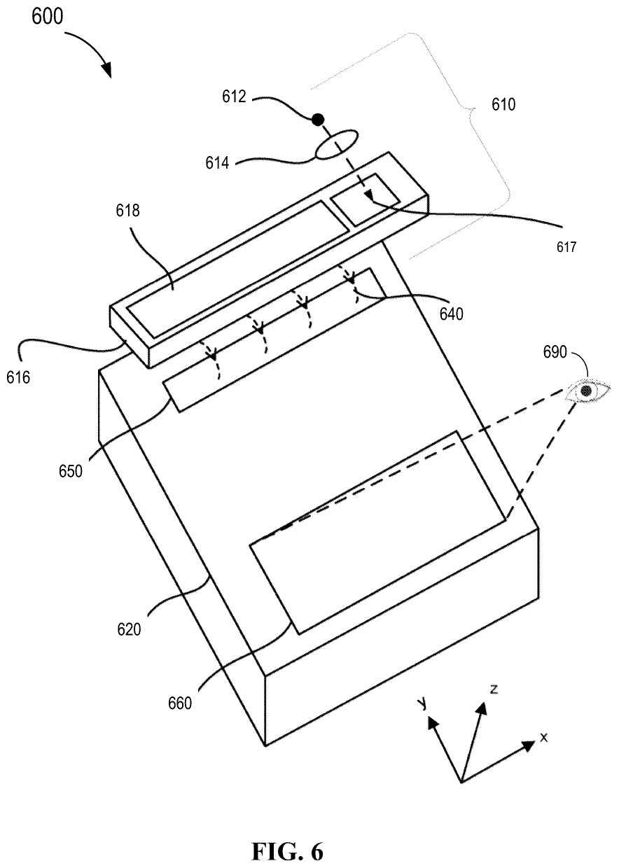

FIG. 7 illustrates an example of a waveguide display 700 including two waveguide assemblies for pupil expansion and a scanning mirror for 2D FOV expansion. Waveguide display 700 may include components similar to components of waveguide display 600 and may include an additional scanning mirror 730 and a controller (not shown in FIG. 7) for controlling the operation of scanning mirror 730. As waveguide display 600, waveguide display 700 may include a light source 712 for generating display light, a projector 714 for projecting the display light onto an input coupler 722 for a first waveguide 720. In some embodiments, the optical power of projector 714 may be adjustable as described above with respect to projector 614.

Input coupler 722 may couple the display light into first waveguide 720 such that the display light may be guided by first waveguide 720 through total internal reflection to propagate within first waveguide 720 in approximately the −x direction. An output coupler 724 may couple a portion of the display light guided by first waveguide 720 out of first waveguide 720, each time the display light is incident on output coupler 724. Therefore, first waveguide 720 may split the display light into multiple display light beams that are output at multiple locations along a first direction (e.g., approximately the x direction). Input coupler 722 may include, for example, a grating, a prism or wedge, or a reflecting surface. Output coupler 724 may include, for example, a surface-relief grating, a holographic grating, an array of transflective mirrors, an array of micro-mirrors, and the like.

The multiple display light beams generated by first waveguide 720 may be reflected by scanning mirror 730 towards an input coupler 742 for a second waveguide 740. Input coupler 742 may couple the display light from scanning mirror 730 into second waveguide 740 such that the display light beams may be guided by second waveguide 740 to propagate along approximately the −y direction. Display light guided by second waveguide 740 may be coupled out of second waveguide 740 towards user's eye 790 (or an eyebox) each time the display light is incident on an output coupler 744. Each of input coupler 742 and output coupler 744 may include, for example, a surface-relief grating, a holographic grating, an array of transflective mirrors, an array of micro-mirrors, and the like. First waveguide 720 and second waveguide 740 may each include a flat substrate, and the displayed image may be at an image plane that is far (e.g., ≥ 3 meters or at infinity) from user's eye 790.

First waveguide 720 may have a shape of a long bar and may have a small FOV in, for example, the z direction. To increase the FOV of waveguide display 700, scanning mirror 730 may be controlled by a controller (not shown in FIG. 7) that may also control the generation of the display light by light source 712, such that, at different time of an image frame period, display light for different FOVs may be generated by light source 712 and reflected by scanning mirror 730 to appropriate directions towards input coupler 742 for second waveguide 740 to form a two-dimensional image with a large 2D FOV. Scanning mirror 730 may scan incident light in one dimension or two dimensions (e.g. horizontal and/or vertical dimensions), and may include, for example, a galvanometer mirror or MEMS mirrors. In some embodiments, waveguide display 700 may also include display optics (not shown in FIG. 7) between second waveguide 740 and user's eye 790. The display optics may project the displayed image onto an image plane that is at a finite distance (e.g., ≥0.5 m, 1 meters, 2 meters, or 3 meters) in front of user's eye 790.

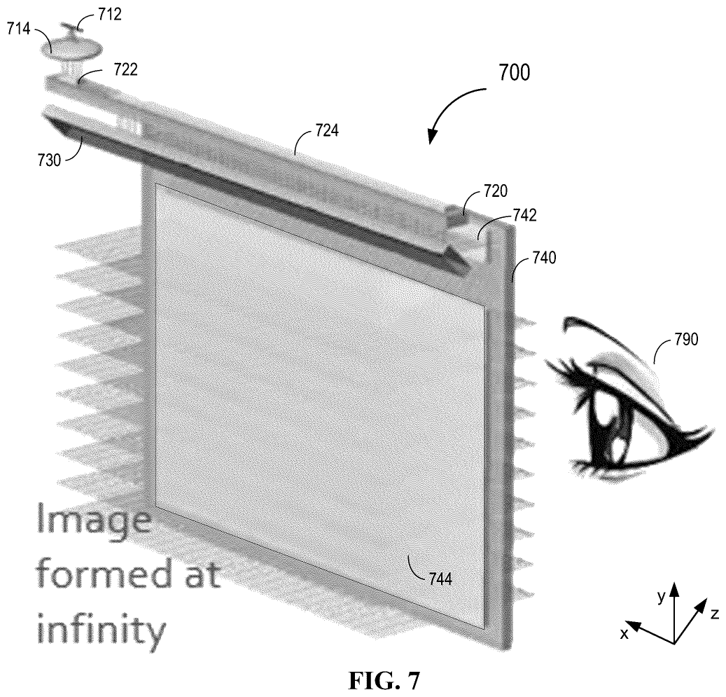

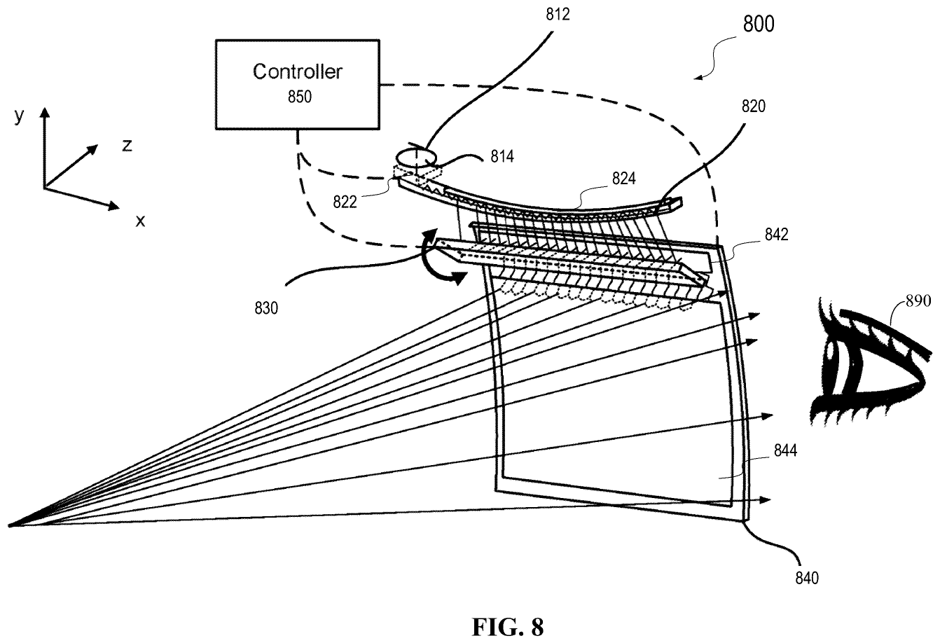

FIG. 8 illustrates an example of a waveguide display 800 including one or more curved waveguides for pupil expansion and a scanning mirror for 2D FOV expansion. Waveguide display 800 may include components similar to components of waveguide display 700, but at least one of the two waveguides may be curved and adjustable to form display images at image planes at desired distances from the user's eye. As illustrated, waveguide display 800 may include a light source 812 for generating display light, a projector 814 for projecting the display light onto a first waveguide 820.

First waveguide 820 may include an input coupler 822 that may couple the display light into first waveguide 820 such that the display light may be guided by first waveguide 820 through total internal reflection. First waveguide 820 may also include an output coupler 824 that may couple a portion of the display light guided by first waveguide 820 out of first waveguide 820, each time the display light is incident on output coupler 824. Therefore, first waveguide 820 may split the display light into multiple display light beams that are output at multiple locations along approximately a first direction (e.g., approximately the x direction). Input coupler 822 may include, for example, a grating, a prism or wedge, or a reflecting surface. Output coupler 824 may include, for example, a surface-relief grating, a holographic grating, an array of transflective mirrors, an array of micro-mirrors, and the like. In the illustrated example, first waveguide 820 may be curved, and thus may converge or diverge the display light.

The multiple display light beams generated by first waveguide 820 may be reflected by scanning mirror 830 towards an input coupler 842 of a second waveguide 840. Input coupler 842 may couple the display light from scanning mirror 830 into second waveguide 840 such that the display light may be guided by second waveguide 840 through total internal reflection. Display light guided by second waveguide 840 may be coupled out of second waveguide 840 towards user's eye 890 (or an eyebox) each time the display light is incident on an output coupler 844. Each of input coupler 842 and output coupler 844 may include, for example, a surface-relief grating, a holographic grating, an array of transflective mirrors, an array of micro-mirrors, and the like. In the illustrated example, second waveguide 840 may include a curved substrate, and thus may converge or diverge the display light such that the display image may be formed at an image plane that is at a desired distance from user's eye 890.

First waveguide 820 may have a shape of a long bar and may have a small FOV in, for example, the z direction. To increase the FOV of waveguide display 800, scanning mirror 830 may be controlled by a controller 850 that may also control the generation of the display light by light source 812, such that, at different time of an image frame period, display light for different FOVs may be generated by light source 812 and reflected by scanning mirror 830 at appropriate directions towards input coupler 842 of second waveguide 840 to form a two-dimensional image with a large 2D FOV. Scanning mirror 830 may scan incident light in one dimension or two dimensions (e.g. horizontal and/or vertical dimensions), and may include, for example, a galvanometer mirror or MEMS mirrors.

In some embodiments, projector 814 may be adjustable to change its optical power as described above with respect to projector 614. In some embodiments, first waveguide 820 and/or second waveguide 840 may include a flexible material (e.g., an organic material), and waveguide display 800 may include one or more actuators that may be controlled by controller 850 to bend first waveguide 820 and/or second waveguide 840. The one or more actuators may include, for example, a strip actuator (e.g., a bimorph strip actuator), a fluidic membrane actuator, a piezoelectric actuator, a MEMS actuator, another actuator, or a combination thereof. The one or more actuators may be placed on one or more surfaces of first waveguide 820 along one or more directions (e.g., the x direction), and/or on one or more surfaces of second waveguide 840 along one or dimensions (e.g., the y direction). In one example, first waveguide 820 may be bent to have a certain curvature to converge or diverge the display light in one dimension (e.g., in x direction), while second waveguide 840 may be bent to have a certain curvature to converge or diverge the display light in another dimension (e.g., in the y direction). As such, the distance of the image plane from user's eye 890 may be adjusted, for example, based on the content of the displayed images, by adjusting the optical power of projector 814, the radius of the curvature of first waveguide 820, the radius of the curvature of second waveguide 840, or a combination thereof.

In some embodiments, waveguide display 800 may also include display optics (e.g., a lens, such as a cylindrical lens or a spherical lens, not shown in FIG. 8) between second waveguide 840 and user's eye 890. The display optics may, in combination with the curved first waveguide 820 and/or second waveguide 840, project the display image at an image plane that is at a finite distance (e.g., ≥0.5 m, 1 meters, 2 meters, or 3 meters) in front of user's eye 890.

Using the scanning mirror (e.g., scanning mirror 730 or 830) for 2D FOV expansion as shown in FIGS. 7 and 8 may need some movable parts in the waveguide display, and may need synchronized control of the light source and the scanning mirror. This may increase the size, complexity, and cost, and reduce the reliability and durability of the waveguide display.

According to certain embodiments, a kaleidoscopic waveguide may be used to replicate the pupil of a waveguide display in one dimension and also increase the FOV of the waveguide display, and thus a scanning mirror may not be used in the waveguide display. The kaleidoscopic waveguide may have a similar shape and size as the bar-shaped waveguides in waveguide displays that use scanning mirrors, but may be configured to guide the display light coupled into the kaleidoscopic waveguide in different manners. For example, display light coupled into a kaleidoscopic waveguide may be reflected by more than two surfaces of the kaleidoscopic waveguide, such as four surfaces of a kaleidoscopic waveguide having a rectangular cross-section, thereby creating multiple images of different parity in each round trip due to the reflection (e.g., including four reflections at the four surfaces due to total internal reflection). The kaleidoscopic waveguide can be configured such that the reflections by sidewalls may not cause optical artifacts or may only cause tolerable optical artifacts, and thus the FOV of the kaleidoscopic waveguide can be large in two dimensions. One or more of the multiple images covering a large 2D FOV may be coupled out of the kaleidoscopic waveguide by, for example, a grating or transflective mirrors, through one surface of the kaleidoscopic waveguide towards a second waveguide. The second waveguide may replicate the exit pupil in another dimension to achieve 2D pupil expansion. In this way, a waveguide display including a kaleidoscopic waveguide may have a small form factor and no moving parts (e.g., a scanning mirror), and may be able to achieve 2D pupil expansion and a large 2D FOV.

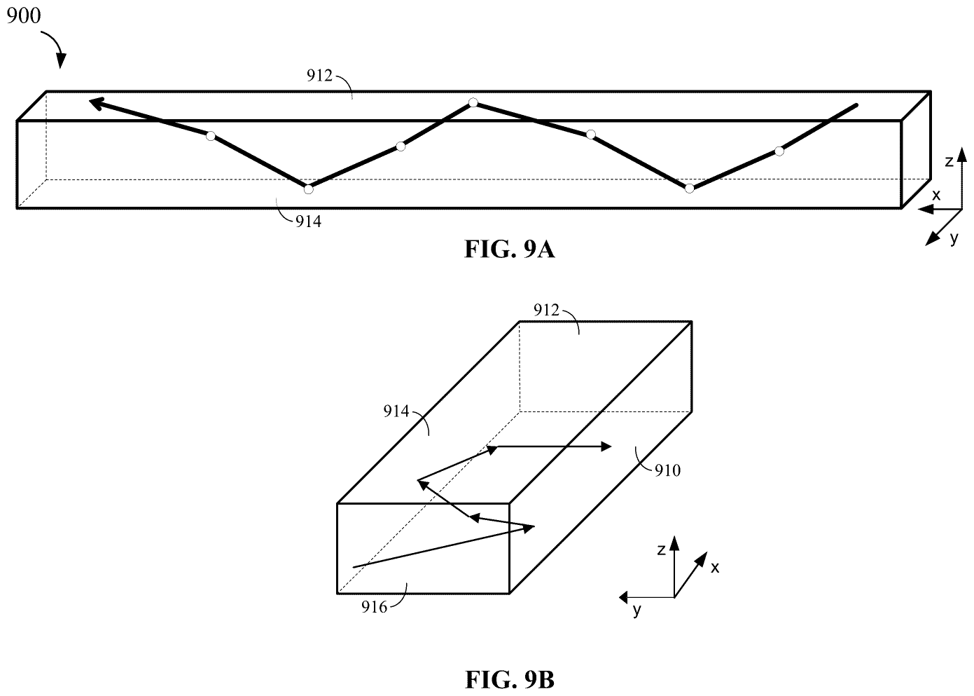

FIGS. 9A and 9B illustrate an example of a kaleidoscopic waveguide 900 for pupil expansion and 2D FOV expansion in a waveguide display according to certain embodiments. Kaleidoscopic waveguide 900 may be used as, for example, first waveguide 616 of waveguide display 600, or may be used to replace first waveguide 720 and scanning mirror 730 of waveguide display 700 or replace first waveguide 820 and scanning mirror 830 of waveguide display 800. In the illustrated example, kaleidoscopic waveguide 900 may have a shape of long bar or tube (e.g., extending in the x direction) with a rectangular cross-section (e.g., in a y-z plane). Kaleidoscopic waveguide 900 may include a material that is transparent to visible light as described above. Kaleidoscopic waveguide 900, an input coupler (not shown in FIGS. 9A and 9B), and a projector (not shown in FIGS. 9A and 9B) of the waveguide display may be arranged such that display light projected by the projector and coupled by the input coupler into kaleidoscopic waveguide 900 may be incident on and reflected by four surfaces of kaleidoscopic waveguide 900 that are parallel to the x direction through total internal reflection, such that the display light may propagate with in kaleidoscopic waveguide 900 in approximately the x direction.

For example, in the embodiment illustrated in FIGS. 9A and 9B, the display light coupled into kaleidoscopic waveguide 900 may be incident on a side surface 910 and reflected by side surface 910 towards a bottom surface 916 through total internal reflection. The display light incident on bottom surface 916 may be reflected by bottom surface 916 towards a side surface 914 through total internal reflection. The display light incident on side surface 914 may be reflected by side surface 914 towards a top surface 912 through total internal reflection. The display light incident on top surface 912 may be reflected by top surface 912 towards side surface 910 through total internal reflection. In this way, when viewed in the x direction, the display light may be reflected by four surfaces of kaleidoscopic waveguide 900 in each round trip.

Even though not shown in FIGS. 9A and 9B, kaleidoscopic waveguide 900 may include one or more output couplers, such as a surface-relief grating, a holographic grating, transflective mirror (partially reflective mirrors), an array of micro-mirrors, and the like, as described in more detail below. The one or more output couplers may split the display light propagating within kaleidoscopic waveguide 900 and couple portions of the display light out of kaleidoscopic waveguide 900 at multiple locations through, for example, bottom surface 916, thereby replicating the exit pupil in one dimension (e.g., the x direction). As first waveguide 616, 720, or 820, kaleidoscopic waveguide 900 may have a relatively large FOV in the dimension in which kaleidoscopic waveguide 900 extends (e.g., the x direction). Due to the reflections at four surfaces of kaleidoscopic waveguide 900 (rather than only the top and bottom surfaces) in each round trip, kaleidoscopic waveguide 900 may also expand the field of view in a second dimension (e.g., the y direction).

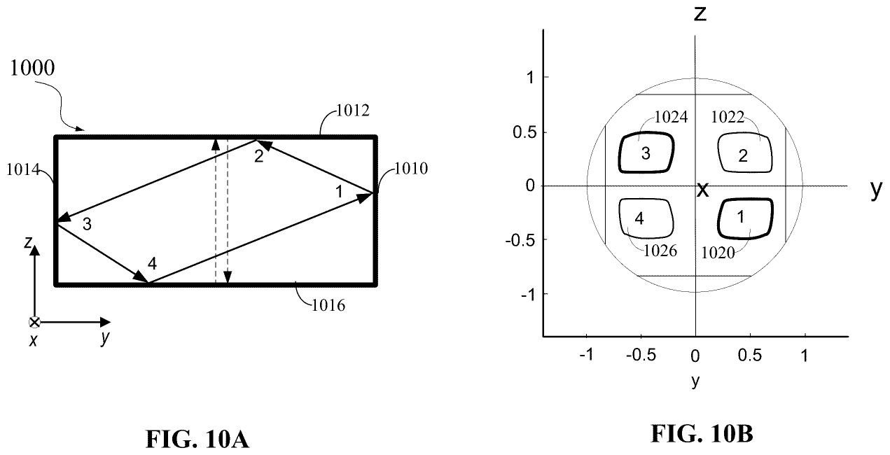

FIG. 10A illustrates light reflections by four surfaces of an example of a kaleidoscopic waveguide 1000 according to certain embodiments. FIG. 10B illustrates wave vectors of display light being reflected by the four surfaces of kaleidoscopic waveguide 1000 of FIG. 10A through total internal reflection according to certain embodiments. In the illustrated example, incident light coupled into kaleidoscopic waveguide 1000 and propagating in approximately the x direction may be reflected at a side surface 1010 of kaleidoscopic waveguide 1000 by a first total internal reflection, and the corresponding wave vectors k (in the y-z plane) of the display light reflected by the first total internal reflection may be shown by a first region 1020 in the y-z plane of the k-space. Display light reflected by the first total internal reflection may then be reflected at a top surface 1012 of kaleidoscopic waveguide 1000 by a second total internal reflection, and the corresponding wave vectors k (in the y-z plane) of the display light reflected by the second total internal reflection may be shown by a second region 1022 in the y-z plane of the k-space. Display light reflected by the second total internal reflection may subsequently be reflected at a side surface 1014 of kaleidoscopic waveguide 1000 by a third total internal reflection, and the corresponding wave vectors k (in the y-z plane) of the display light reflected by the third total internal reflection may be shown by a third region 1024 in the y-z plane of the k-space. Display light reflected by the third total internal reflection may subsequently be reflected at a bottom surface 1016 of kaleidoscopic waveguide 1000 by a fourth total internal reflection, and the corresponding wave vectors k (in the y-z plane) of the display light reflected by the fourth total internal reflection may be shown by a fourth region 1026 in the y-z plane of the k-space. As such, four copies of the display image with different parity may be created by the reflections at the four surfaces in each round trip.

FIG. 10A also shows the reflection of the display light by only the top and bottom surfaces of a bar-shaped waveguide, where the display light may propagate within the waveguide in the z direction in addition to the x direction and may have a line FOV (e.g., with an FOV about 0° in the y direction). In contrast, in kaleidoscopic waveguide 1000, the display light may propagate within the waveguide in both the y and z directions (in addition to the x direction) in each round trip. Kaleidoscopic waveguide 1000 can be configured such that the reflections by sidewalls can be tolerated, and thus the FOV of kaleidoscopic waveguide 1000 does not need to be a line FOV to avoid reflections by sidewalls and can be large in the y direction as well. As such, the FOV of the display light guided by kaleidoscopic waveguide 1000 may be expanded in the y direction.

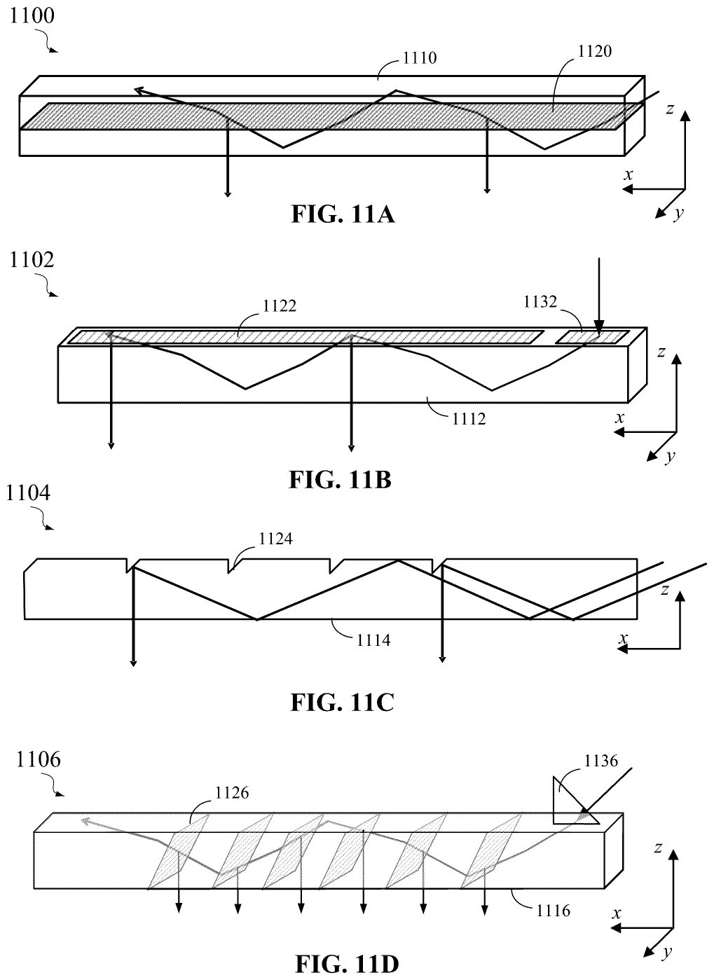

FIG. 11A illustrates an example of a kaleidoscopic waveguide 1100 including an embedded grating 1120 for coupling display light out of the kaleidoscopic waveguide according to certain embodiments. In the example shown in FIG. 11A, the display light may be coupled into a waveguide 1110 (e.g., a bar-shaped waveguide formed by two bonded substrates) from a side of waveguide 1110 by, for example, a wedge or prism at the side of waveguide 1110, such that the display light may propagate within waveguide 1110 through total internal reflections at four surfaces of waveguide 1110 as described above. Embedded grating 1120 may be sandwiched by the two substrates and may be used to couple the display light guided by waveguide 1110 out of a bottom surface of waveguide 1110 at multiple locations along the x directions.

Embedded grating 1120 may include thick VBGs recorded in a thick holographic material layer (e.g., with a thickness greater than about 10 μm, about 20 μm, about 50 μm, or higher). The thick holographic material layer may allow more VBGs for different FOV ranges to be recorded therein, and thus may support a large overall field of view. Each thick VBG recorded in the thick holographic material layer may have a high angular selectivity, and may be able to achieve a higher diffraction efficiency in the corresponding field of view and a lower dispersion for visible light of different colors, compared with a thinner VBG. The higher angular selectivity of the thick VBGs may help to reduce ghost images caused by the multiple total internal reflections, and thus may improve the quality of the displayed images,

FIG. 11B illustrates an example of a kaleidoscopic waveguide 1102 including a pair of gratings for coupling display light into and out of a waveguide 1112 according to certain embodiments. Waveguide 1112 may include a bar-shaped substrate. An input grating 1132 and an output grating 1122 may be formed on one or two surfaces of waveguide 1112. Input grating 1132 may be configured to couple display light from a projector into waveguide 1112 at certain directions such that the display light may propagate within waveguide 1112 through total internal reflections at four surfaces of waveguide 1112 as described above. Output grating 1122 may couple the display light guided by waveguide 1112 out of a bottom surface of waveguide 1112 at multiple locations along the x directions.

Each of input grating 1132 and output grating 1122 may include, for example, a surface-relief grating, a holographic grating, a PVH, or another diffractive grating. In one example, input grating 1132 and output grating 1122 may each include a plurality of multiplexed VBGs, where a VBG in input grating 1132 and a corresponding VBG in output grating 1122 that cover the same FOV range and wavelength range may have matching grating vectors (e.g., having the same grating vector in the x-y plane and having the same or opposite grating vectors in the z direction). The VBG in input grating 1132 may couple the display light within an FOV range and a wavelength range into waveguide 1112, while the VBG in output grating 1122 may couple the display light within the FOV range and the wavelength range out of waveguide 1112. Due to the opposite diffraction directions and thus opposite Bragg conditions (e.g., +1 order and −1 order diffractions) for the diffractions at input grating 1132 and output grating 1122, input grating 1132 and output grating 1122 may compensate for the light dispersion caused by each other to reduce the overall dispersion, even if each of input grating 1132 and output grating 1122 may be thin and may have a high dispersion. Thus, input grating 1132 and output grating 1122 can be formed in a thin grating layer (e.g., a thin holographic material layer with a thickness less than about 20 μm, about 10 μm, about 5 μm, or thinner), and thus kaleidoscopic waveguide 1102 can have lower haze caused by the grating layer (and higher transparency for see-thought light).

FIG. 11C illustrates an example of a kaleidoscopic waveguide 1104 including a micro-mirror array for coupling display light out of a waveguide 1114 according to certain embodiments. Waveguide 1114 may include a bar-shaped substrate. In the example shown in FIG. 11C, the display light may be coupled into waveguide 1114 from a side of waveguide 1114 by, for example, a wedge, a prism, or a reflecting surface at the side of waveguide 1114, such that the display light may propagate within waveguide 1114 through total internal reflection at four surfaces of waveguide 1114 as described above. Waveguide 1114 may include an array of micro-mirrors 1124 formed at a surface (e.g., the top surface) of waveguide 1114. The array of micro-mirrors 1124 may be formed by forming an array of shallow grooves with certain slant angles (e.g., by cutting using diamond or by molding) and coating the surfaces of the shallow grooves with reflective coating. The array of micro-mirrors 1124 may be spaced apart by uncoated flat regions of the top surface of waveguide 1114, through which ambient light may pass through and the display light may be reflected by total internal reflection. The array of micro-mirrors 1124 may be configured to couple the display light guided by waveguide 1114 out of a bottom surface of waveguide 1114 at multiple locations along the x directions. Compared with diffractive couplers, the array of micro-mirrors 1124 can have higher coupling efficiencies, and can have wider angular and wavelength bandwidths and lower dispersion. The fabrication may be relatively easy and have a lower cost. A better color/intensity uniformity may also be achieved with micro-mirrors 1124.

FIG. 11D illustrates an example of a kaleidoscopic waveguide 1106 including transflective mirrors 1126 for coupling display light out of a waveguide 1116 according to certain embodiments. Waveguide 1116 may include a bar-shaped substrate. An input coupler 1136 (e.g., a prism, a wedge, a reflective surface, or a diffractive grating) may be configured to couple display light from a projector into waveguide 1116 at certain directions such that the display light may propagate within waveguide 1116 through total internal reflections at four surfaces of waveguide 1116 as described above. An array of transflective mirrors 1126 may be embedded in waveguide 1116 and may couple the display light guided by waveguide 1116 out of a bottom surface of waveguide 1116 at multiple locations along the x directions. In various embodiments, transflective mirrors 1126 may have any suitable shape and/or size, and may be fully embedded or partially embedded in waveguide 1116.

Transflective mirrors 1126 may be partially reflective and partially transmissive, and may split incident light by partially reflecting incident light and partially transmitting the incident light, such that a portion of the incident light may be reflected and coupled out of waveguide 1116, while a portion of the incident light may continue to propagate within the waveguide to be split by other transflective mirrors. Each transflective mirror 1126 may include, for example, a plurality of dielectric coating layers, one or more metal coating layers, or a combination of dielectric coating layers and metal coating layers. For example, a transflective mirror 1126 may include a plurality of dielectric coating layers coated on a substrate (e.g., a glass substrate), where the plurality of dielectric coating layers may include two or more different transparent dielectric materials having different refractive indices. The number of dielectric coating layers, and the refractive index and the thickness of each dielectric coating layer may be selected to achieve the desired performance, such as the desired reflectivity (reflection efficiency) and polarization performance. A plurality of substrates each with a transflective mirror 1126 formed thereon may be stacked and bonded (e.g., glued) together using, for example, optically clear adhesives. The bonded stack may be cut at a certain angle to form one or more geometrical waveguides each including a plurality of transflective mirrors 1126 embedded therein and having certain desired slant angles.

Different transflective mirrors 1126 in the array of transflective mirrors 1126 may have different reflectivity efficiencies. For example, the reflectivity of a first transflective mirror 1126 that may receive the display light before a second transflective mirror 1126 may have a lower reflectivity than the second transflective mirror 1126, such that the portion of the display light reflected by the first transflective mirror 1126 may have a similar intensity as the portion of the display light reflected by the second transflective mirror 1126. Transflective mirrors 1126 may have much wider angular and spectral bandwidths and may have higher efficiency than grating based couplers.

In other embodiments, various combinations of the different input couplers and output couplers may be used to couple display light into or out of the kaleidoscopic waveguides. In some embodiments, the kaleidoscopic waveguide may include a long bar-shaped substrate made of a transparent material and having various cross-sectional shapes.

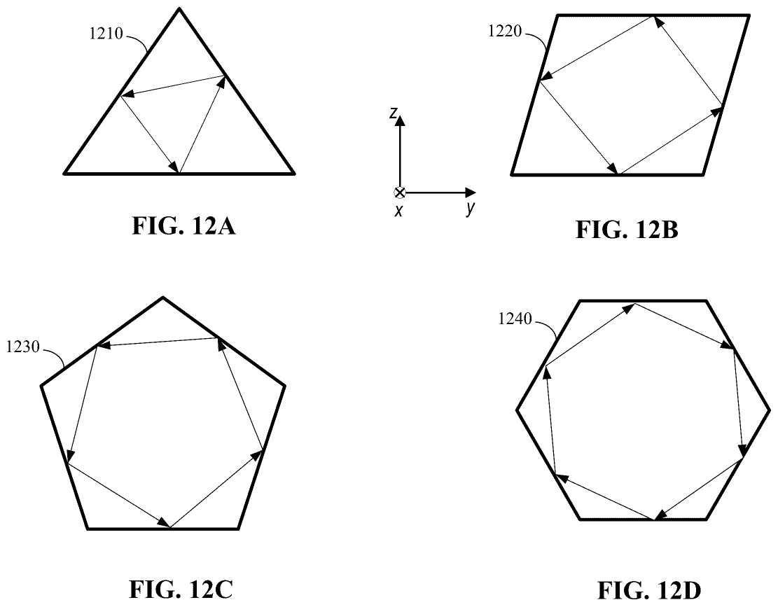

FIGS. 12A-12D illustrate examples of kaleidoscopic waveguides having different cross-sectional shapes according to certain embodiments. In the example illustrated in FIG. 12A, a kaleidoscopic waveguide 1210 may have a triangular cross-section, where the display light coupled into kaleidoscopic waveguide 1210 may be guided by kaleidoscopic waveguide 1210 through total internal reflection at three surfaces of kaleidoscopic waveguide 1210, thereby expanding the FOV of kaleidoscopic waveguide 1210 as described above with respect to, for example, FIGS. 10A and 10B, compared with the FOV of first waveguide 720 or 820 described above. Display light propagating within kaleidoscopic waveguide 1210 may be coupled out of kaleidoscopic waveguide 1210 at multiple locations along the propagating direction (e.g., the x direction in the illustrated example) by, for example, a surface-relief grating, a thin or thick holographic grating, a PVH, an array of micro-mirrors, an array of transflective mirrors, and the like, as described above with respect to, for example, FIGS. 11A-11D.

In the example illustrated in FIG. 12B, a kaleidoscopic waveguide 1220 may have a cross-section with a shape of a parallelogram, where the display light coupled into kaleidoscopic waveguide 1220 may be guided by kaleidoscopic waveguide 1220 through total internal reflection at four surfaces of kaleidoscopic waveguide 1220, thereby expanding the FOV of kaleidoscopic waveguide 1220 as described above with respect to, for example, FIGS. 10A and 10B, compared with the FOV of first waveguide 720 or 820 described above. Display light propagating within kaleidoscopic waveguide 1220 may be coupled out of kaleidoscopic waveguide 1220 at multiple locations along the propagating direction (e.g., the x direction in the illustrated example) by, for example, a surface-relief grating, a thin or thick holographic grating, a PVH, an array of micro-mirrors, an array of transflective mirrors, and the like, as described above with respect to, for example, FIGS. 11A-11D.

In the example illustrated in FIG. 12C, a kaleidoscopic waveguide 1230 may have a cross-section with a shape of a pentagon, where the display light coupled into kaleidoscopic waveguide 1230 may be guided by kaleidoscopic waveguide 1230 through total internal reflection at five surfaces of kaleidoscopic waveguide 1230, thereby expanding the FOV of kaleidoscopic waveguide 1230 as described above with respect to, for example, FIGS. 10A and 10B, compared with the FOV of first waveguide 720 or 820 described above. Display light propagating within kaleidoscopic waveguide 1230 may be coupled out of kaleidoscopic waveguide 1230 at multiple locations along the propagating direction (e.g., the x direction in the illustrated example) by, for example, a surface-relief grating, a thin or thick holographic grating, a PVH, an array of micro-mirrors, an array of transflective mirrors, and the like, as described above with respect to, for example, FIGS. 11A-11D.

In the example illustrated in FIG. 12D, a kaleidoscopic waveguide 1240 may have a cross-section with a shape of a hexagon, where the display light coupled into kaleidoscopic waveguide 1240 may be guided by kaleidoscopic waveguide 1240 through total internal reflection at six surfaces of kaleidoscopic waveguide 1240, thereby expanding the FOV of kaleidoscopic waveguide 1240 as described above with respect to, for example, FIGS. 10A and 10B, compared with the FOV of first waveguide 720 or 820 described above. Display light propagating within kaleidoscopic waveguide 1240 may be coupled out of kaleidoscopic waveguide 1240 at multiple locations along the propagating direction (e.g., the x direction in the illustrated example) by, for example, a surface-relief grating, a thin or thick holographic grating, a PVH, an array of micro-mirrors, an array of transflective mirrors, and the like, as described above with respect to, for example, FIGS. 11A-11D.

Due to the 2D FOV expansion by the kaleidoscopic waveguides disclosed herein, scanning mirrors such as scanning mirror 730 or 830 may not be needed. Display light coupled out of the kaleidoscopic waveguides may be directly coupled into a second waveguide by an input coupler and may be coupled out of the second waveguides at multiple locations for additional pupil expansion, as described above with respect to, for example, FIG. 6.

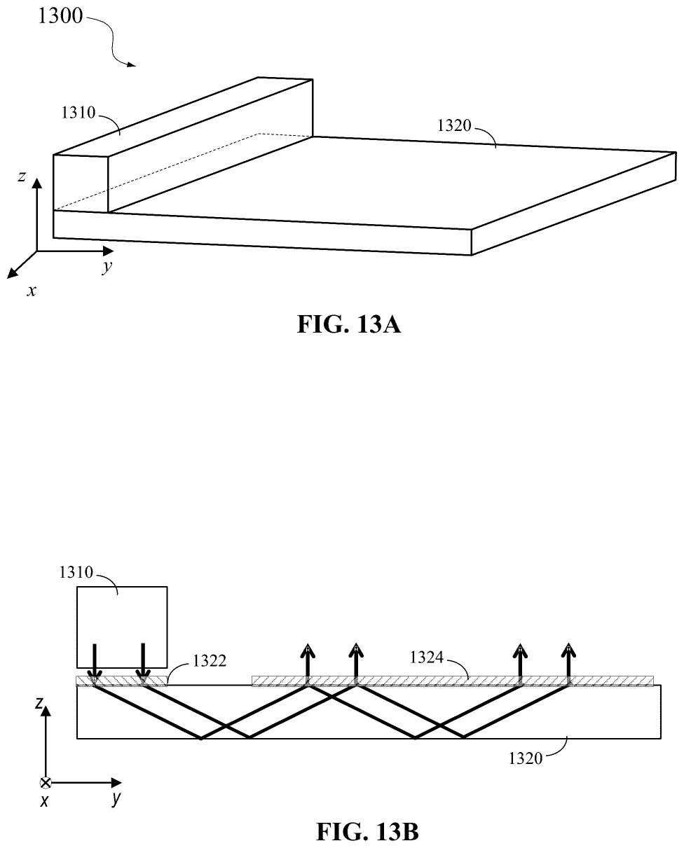

FIGS. 13A and 13B illustrate an example of a waveguide display 1300 including a kaleidoscopic waveguide for pupil expansion and 2D FOV expansion according to certain embodiments. Waveguide display 1300 may include a first waveguide 1310 and a second waveguide 1320, where first waveguide 1310 may be on top of an input region of second waveguide 1320 and may be positioned at a certain orientation (e.g., with edges aligned or at a certain angle) with respect to second waveguide 1320. As described above with respect to FIGS. 9A-10B, first waveguide 1310 may be a kaleidoscopic waveguide including an input coupler and an output coupler, and may extend in a first direction (e.g., the x direction). Display light from a projector may be coupled into first waveguide 1310, for example, as described above with respect to FIGS. 11A-11D, and may propagate within first waveguide 1310 in the first direction (e.g., the x direction) due to total internal reflection at four surfaces of first waveguide 1310 that are parallel to the first direction (e.g., the x direction). As described above with respect to FIGS. 11A-11D, the display light propagating within first waveguide 1310 may be coupled out of first waveguide 1310 by an output coupler (e.g., a grating coupler, an array of transflective mirrors, or an array of micro-mirrors) at multiple locations along the first direction (e.g., the x direction) to replicate the exit pupil in the first direction and provide 2D FOV expansion.

In the illustrated example, the display light coupled out of first waveguide 1310 at each of the multiple locations along the first direction may be coupled into second waveguide 1320 by a first grating coupler 1322, such as a surface-relief grating, a holographic grating, or a polarization volume hologram. The display light coupled into second waveguide 1320 may propagate within second waveguide 1320 in a second direction (e.g., the y direction), and may be coupled out of second waveguide 1320 by a second grating coupler 1324 at multiple locations along approximately the second direction (e.g., the y direction) so as to replicate the exit pupil in the second direction. Second grating coupler 1324 may include, for example, a surface-relief grating, a holographic grating, an array of transflective mirrors, or a polarization volume hologram. As described above with respect to FIG. 11B, first grating coupler 1322 and second grating coupler 1324 may having matching grating vectors and may compensate for the dispersion caused by each other to achieve a low overall dispersion.

Even though first waveguide 1310 and second waveguide 1320 in the example illustrated in FIGS. 13A and 13B may be flat, in some embodiments, first waveguide 1310 and/or second waveguide 1320 may be curved. In some embodiments, the curvature of first waveguide 1310 and/or second waveguide 1320 may be adjustable using one or more actuators as described above with respect to, for example, FIGS. 6-8.

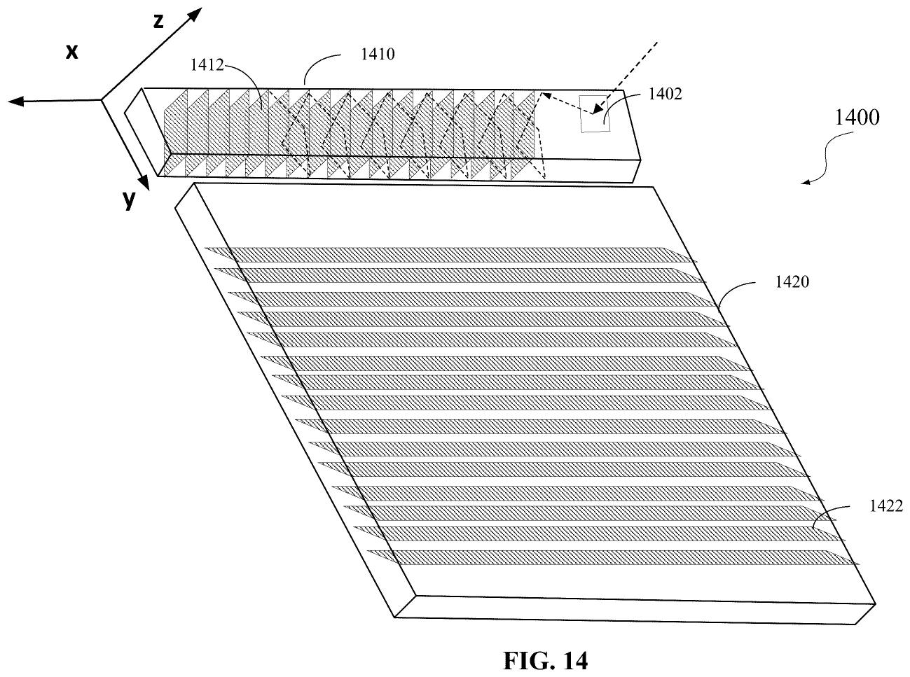

FIG. 14 illustrates an example of a geometrical waveguide display 1400 including a kaleidoscopic geometrical waveguide for pupil expansion and 2-D FOV expansion according to certain embodiments. Geometrical waveguide display 1400 may include a first geometrical waveguide 1410 and a second geometrical waveguide 1420, where first geometrical waveguide 1410 may be adjacent to one edge or on top of an input region of second geometrical waveguide 1420, and may be positioned at a certain orientation (e.g., with edges aligned or at a certain angle) with respect to second geometrical waveguide 1420. First geometrical waveguide 1410 may be a kaleidoscopic geometrical waveguide as described above with respect to FIGS. 9A-12D. First geometrical waveguide 1410 may include an array of transflective mirrors 1412 for coupling portions of light propagating within first geometrical waveguide 1410 out of first geometrical waveguide 1410 towards second geometrical waveguide 1420. Second geometrical waveguide 1420 may include an array of transflective mirrors 1422 configured to couple display light out of second geometrical waveguide 1420.

As described above, transflective mirrors 1412 and 1422 may be partially reflective and partially transmissive, and may split incident light by partially reflecting incident light and partially transmitting the incident light, such that a portion of the incident light may be reflected and coupled out of the waveguide, while a portion of the incident light may continue to propagate within the waveguide to be split by other transflective mirrors. Each transflective mirror may include, for example, a plurality of dielectric coating layers, one or more metal coating layers, or a combination of dielectric coating layers and metal coating layers. For example, a transflective mirror may include a plurality of dielectric coating layers coated on a substrate (e.g., a glass substrate), where the plurality of dielectric coating layers may include two or more different transparent dielectric materials having different refractive indices. The number of dielectric coating layers, and the refractive index and the thickness of each dielectric coating layer may be selected to achieve the desired performance, such as the desired reflectivity, wavelength and angular bandwidth, and polarization performance. A plurality of substrates each with a transflective mirror formed thereon may be stacked and bonded (e.g., glued) together using, for example, optically clear adhesives. The bonded stack may be cut at a certain angle to form one or more geometrical waveguides each including a plurality of transflective mirrors embedded therein and having certain desired tilt angles.

In the example shown in FIG. 14, the display light may be coupled into first geometrical waveguide 1410 by an input coupler 1402, such as a grating, a wedge, or a prism, such that the display light may propagate within first geometrical waveguide 1410 through total internal reflections at four surfaces of first geometrical waveguide 1410 as described above. Therefore, the display light can have a wide FOV in both the x direction and the y direction. Due to the FOV expansion by the kaleidoscopic waveguide, scanning mirrors such as scanning mirror 730 or 830 may not be needed. Transflective mirrors 1412 may couple the display light guided by first geometrical waveguide 1410 out of a surface (e.g., a bottom or sidewall surface) of first geometrical waveguide 1410 at multiple locations along the x directions to replicate the pupil along the x direction.

Display light coupled out of first geometrical waveguide 1410 may be coupled into second geometrical waveguide 1420 directly or by a coupler, through an edge of second geometrical waveguide 1420, to propagate in approximately the y direction within second geometrical waveguide 1420 due to total internal reflection at surfaces of second geometrical waveguide 1420. Display light propagating within second geometrical waveguide 1420 may be coupled out of second geometrical waveguide 1420 (e.g., in directions around the +z or −z direction) at a plurality of locations along approximately the y direction by transflective mirrors 1422. As such, the display light may be replicated along approximately the y direction by second geometrical waveguide 1420. Therefore, first geometrical waveguide 1410 and second geometrical waveguide 1420 in combination may replicate the display light in two dimensions.

In some embodiments, different transflective mirrors in the array of transflective mirrors 1412 or 1422 may have different reflectivity efficiencies. For example, the reflectivity of a first transflective mirror 1412 that may receive the display light before a second transflective mirror 1412 may have a lower reflectivity than the second transflective mirror 1412, such that the portion of the display light reflected by the first transflective mirror 1412 may have a similar intensity as the portion of the display light reflected by the second transflective mirror 1412. Transflective mirrors 1412 and 1422 may have much wider angular and spectral bandwidths and may have higher efficiency than grating based couplers.

In one example of geometrical waveguide display 1400, transflective mirrors 1412 may be oriented at about 60° (e.g., within about +5% or +10%) with respect to the x direction or an x-z plane, and transflective mirrors 1422 may be oriented at about 36° (e.g., within about +5% or +10%) with respect to the y direction or an x-y plane. First geometrical waveguide 1410 (a kaleidoscopic geometrical waveguide) and second geometrical waveguide 1420 may be positioned side-by-side as shown in FIG. 14, where an air gap or a low refractive index material may be between first geometrical waveguide 1410 and second geometrical waveguide 1420, to cause total internal reflection at the surface of first geometrical waveguide 1410 facing second geometrical waveguide 1420. The thicknesses (in z direction) of first geometrical waveguide 1410 and second geometrical waveguide 1420 may be, for example, about 1 mm in the z direction, and the width of first geometrical waveguide 1410 may be about, for example, 5 mm in the y direction.

In some embodiments, geometrical waveguide display 1400 may include a mirror (not shown) on a surface of first geometrical waveguide 1410 opposing second geometrical waveguide 1420. The mirror may have a reflectivity close to 100% such that images may not be coupled out of first geometrical waveguide 1410 from the surface, and may be further reflected until they are coupled out of first geometrical waveguide 1410 through the surface facing second geometrical waveguide 1420. Display light coupled out of the surface of first geometrical waveguide 1410 facing second geometrical waveguide 1420 may then be coupled into second geometrical waveguide 1420.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

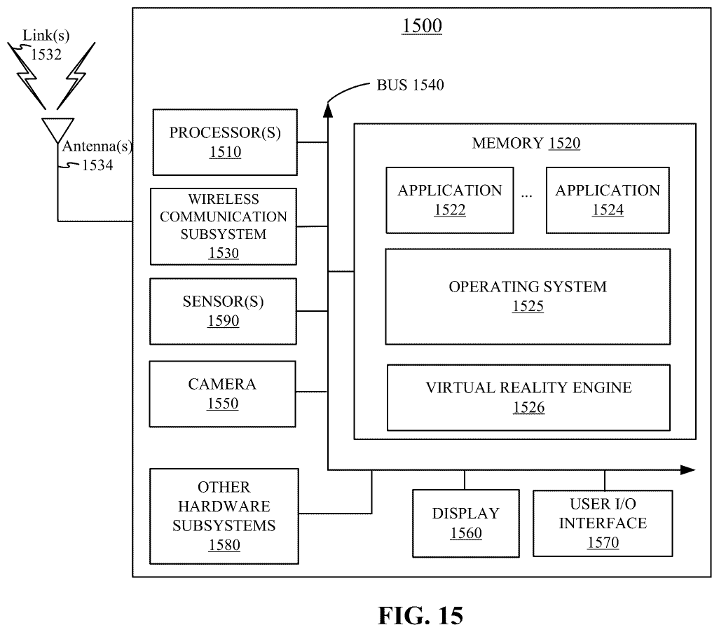

FIG. 15 is a simplified block diagram of an example electronic system 1500 of an example near-eye display (e.g., HMD device) for implementing some of the examples disclosed herein. Electronic system 1500 may be used as the electronic system of an HMD device or other near-eye displays described above. In this example, electronic system 1500 may include one or more processor(s) 1510 and a memory 1520. Processor(s) 1510 may be configured to execute instructions for performing operations at a number of components, and can be, for example, a general-purpose processor or microprocessor suitable for implementation within a portable electronic device. Processor(s) 1510 may be communicatively coupled with a plurality of components within electronic system 1500. To realize this communicative coupling, processor(s) 1510 may communicate with the other illustrated components across a bus 1540. Bus 1540 may be any subsystem adapted to transfer data within electronic system 1500. Bus 1540 may include a plurality of computer buses and additional circuitry to transfer data.

Memory 1520 may be coupled to processor(s) 1510. In some embodiments, memory 1520 may offer both short-term and long-term storage and may be divided into several units. Memory 1520 may be volatile, such as static random access memory (SRAM) and/or dynamic random access memory (DRAM) and/or non-volatile, such as read-only memory (ROM), flash memory, and the like. Furthermore, memory 1520 may include removable storage devices, such as secure digital (SD) cards. Memory 1520 may provide storage of computer-readable instructions, data structures, program code, and other data for electronic system 1500. In some embodiments, memory 1520 may be distributed into different hardware subsystems. A set of instructions and/or code might be stored on memory 1520. The instructions might take the form of executable code that may be executable by electronic system 1500, and/or might take the form of source and/or installable code, which, upon compilation and/or installation on electronic system 1500 (e.g., using any of a variety of generally available compilers, installation programs, compression/decompression utilities, etc.), may take the form of executable code.

In some embodiments, memory 1520 may store a plurality of applications 1522 through 1524, which may include any number of applications. Examples of applications may include gaming applications, conferencing applications, video playback applications, or other suitable applications. The applications may include a depth sensing function or eye tracking function. Applications 1522-1524 may include particular instructions to be executed by processor(s) 1510. In some embodiments, certain applications or parts of applications 1522-1524 may be executable by other hardware subsystems 1580. In certain embodiments, memory 1520 may additionally include secure memory, which may include additional security controls to prevent copying or other unauthorized access to secure information.

In some embodiments, memory 1520 may include an operating system 1525 loaded therein. Operating system 1525 may be operable to initiate the execution of the instructions provided by applications 1522-1524 and/or manage other hardware subsystems 1580 as well as interfaces with a wireless communication subsystem 1530 which may include one or more wireless transceivers. Operating system 1525 may be adapted to perform other operations across the components of electronic system 1500 including threading, resource management, data storage control and other similar functionality.

Wireless communication subsystem 1530 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1500 may include one or more antennas 1534 for wireless communication as part of wireless communication subsystem 1530 or as a separate component coupled to any portion of the system. Depending on desired functionality, wireless communication subsystem 1530 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1530 may permit data to be exchanged with a network, other computer systems, and/or any other devices described herein. Wireless communication subsystem 1530 may include a means for transmitting or receiving data, such as identifiers of HMD devices, position data, a geographic map, a heat map, photos, or videos, using antenna(s) 1534 and wireless link(s) 1532.

Embodiments of electronic system 1500 may also include one or more sensors 1590. Sensor(s) 1590 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1590 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1500 may include a display 1560. Display 1560 may be a near-eye display, and may graphically present information, such as images, videos, and various instructions, from electronic system 1500 to a user. Such information may be derived from one or more applications 1522-1524, virtual reality engine 1526, one or more other hardware subsystems 1580, a combination thereof, or any other suitable means for resolving graphical content for the user (e.g., by operating system 1525). Display 1560 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 1500 may include a user input/output interface 1570. User input/output interface 1570 may allow a user to send action requests to electronic system 1500. An action request may be a request to perform a particular action. For example, an action request may be to start or end an application or to perform a particular action within the application. User input/output interface 1570 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1500. In some embodiments, user input/output interface 1570 may provide haptic feedback to the user in accordance with instructions received from electronic system 1500. For example, the haptic feedback may be provided when an action request is received or has been performed.

Electronic system 1500 may include a camera 1550 that may be used to take photos or videos of a user, for example, for tracking the user's eye position. Camera 1550 may also be used to take photos or videos of the environment, for example, for VR, AR, or MR applications. Camera 1550 may include, for example, a complementary metal-oxide-semiconductor (CMOS) image sensor with a few millions or tens of millions of pixels. In some implementations, camera 1550 may include two or more cameras that may be used to capture 3-D images.

In some embodiments, electronic system 1500 may include a plurality of other hardware subsystems 1580. Each of other hardware subsystems 1580 may be a physical subsystem within electronic system 1500. While each of other hardware subsystems 1580 may be permanently configured as a structure, some of other hardware subsystems 1580 may be temporarily configured to perform specific functions or temporarily activated. Examples of other hardware subsystems 1580 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1580 may be implemented in software.

In some embodiments, memory 1520 of electronic system 1500 may also store a virtual reality engine 1526. Virtual reality engine 1526 may execute applications within electronic system 1500 and receive position information, acceleration information, velocity information, predicted future positions, or some combination thereof of the HMD device from the various sensors. In some embodiments, the information received by virtual reality engine 1526 may be used for producing a signal (e.g., display instructions) to display 1560. For example, if the received information indicates that the user has looked to the left, virtual reality engine 1526 may generate content for the HMD device that mirrors the user's movement in a virtual environment. Additionally, virtual reality engine 1526 may perform an action within an application in response to an action request received from user input/output interface 1570 and provide feedback to the user. The provided feedback may be visual, audible, or haptic feedback. In some implementations, processor(s) 1510 may include one or more GPUs that may execute virtual reality engine 1526.

In various implementations, the above-described hardware and subsystems may be implemented on a single device or on multiple devices that can communicate with one another using wired or wireless connections. For example, in some implementations, some components or subsystems, such as GPUs, virtual reality engine 1526, and applications (e.g., tracking application), may be implemented on a console separate from the head-mounted display device. In some implementations, one console may be connected to or support more than one HMD.

In alternative configurations, different and/or additional components may be included in electronic system 1500. Similarly, functionality of one or more of the components can be distributed among the components in a manner different from the manner described above. For example, in some embodiments, electronic system 1500 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC. AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A waveguide display comprising:
a first waveguide assembly comprising:
a first waveguide extending in a first direction;
a first input coupler configured to couple display light into the first waveguide such that the display light is reflected through total internal reflection by three or more surfaces of the first waveguide that are parallel to the first direction to propagate within the first waveguide in the first direction; and
a first output coupler configured to couple the display light out of the first waveguide at a first plurality of locations along the first direction; and
a second waveguide assembly configured to deflect, at a second plurality of locations along a second direction different from the first direction, the display light from the first waveguide towards an eyebox of the waveguide display.

2. The waveguide display of claim 1, wherein the first waveguide has a bar shape and has a cross-section characterized by a shape of a polygon.

3. The waveguide display of claim 1, wherein the first input coupler comprises a prism, a wedge, a surface-relief grating, a holographic grating, a polarization volume hologram, or a reflective surface.

4. The waveguide display of claim 1, wherein the first output coupler comprises a surface-relief grating, a holographic grating, a polarization volume hologram, an array of partially reflective mirrors embedded in the first waveguide, or an array of micro-mirrors formed at a surface of the first waveguide.

5. The waveguide display of claim 1, wherein at least one of the first waveguide or the second waveguide assembly is curved.

6. The waveguide display of claim 1, wherein:
at least one of the first waveguide assembly or the second waveguide assembly is flexible; and
the waveguide display includes one or more actuators configured to bend at least one of the first waveguide assembly or the second waveguide assembly.

7. The waveguide display of claim 1, wherein the second waveguide assembly comprises:
a second waveguide larger than the first waveguide;
a second input coupler configured to couple the display light coupled out of the first waveguide at the first plurality of locations along the first direction into the second waveguide; and
a second output coupler configured to couple the display light out of the second waveguide at the second plurality of locations along the second direction.

8. The waveguide display of claim 7, wherein the second output coupler comprises a surface-relief grating, a holographic grating, a polarization volume hologram, an array of partially reflective mirrors embedded in the second waveguide, or an array of micro-mirrors formed at a surface of the second waveguide.

9. The waveguide display of claim 1, wherein the first waveguide assembly is on an input area of the second waveguide assembly and is separated from the second waveguide assembly by an air gap.

10. The waveguide display of claim 1, wherein the first waveguide assembly and the second waveguide assembly are arranged side-by-side and are separate from each other by an air gap.

11. The waveguide display of claim 1, wherein the first waveguide is characterized by a width less than 10 mm in a direction perpendicular to the first direction.

12. The waveguide display of claim 1, wherein a field of view of the waveguide display is greater than 60°×40°.

13. The waveguide display of claim 1, where the first output coupler is configured to couple the display light out of the first waveguide through one surface of the first waveguide.

14. The waveguide display of claim 1, where the first output coupler is configured to couple the display light reflected by a single surface of the three or more surfaces out of the first waveguide.

15. A near-eye display system comprising:
an image source configured to emit display light of images;
display optics configured to project the display light;
a first pupil expander extending in a first direction, the first pupil expander configured to:
reflect the display light from the display optics through total internal reflection at 5 three or more surfaces that are parallel to the first direction to guide the display light in the first direction; and
couple the display light out of the first pupil expander at a first plurality of locations along the first direction; and
a second pupil expander configured to split the display light from each location of the first plurality of locations of the first pupil expander at a second plurality of locations along a second direction that is different from the first direction.

16. The near-eye display system of claim 15, wherein the first pupil expander has a bar shape and has a cross-section characterized by a shape of a polygon.

17. The near-eye display system of claim 15, wherein the first pupil expander comprises:
a first waveguide extending in the first direction;
a first input coupler configured to couple the display light into the first waveguide such that the display light is reflected through total internal reflection by the three or more surfaces of the first waveguide that are parallel to the first direction to propagate within the first waveguide in the first direction; and
a first output coupler configured to couple the display light out of the first waveguide at the first plurality of locations along the first direction.

18. The near-eye display system of claim 17, wherein the first input coupler comprises a prism, a wedge, a surface-relief grating, a holographic grating, a polarization volume hologram, or a reflective surface.

19. The near-eye display system of claim 17, wherein the first output coupler comprises a surface-relief grating, a holographic grating, a polarization volume hologram, an array of partially reflective mirrors embedded in the first waveguide, or an array of micro-mirrors formed at a surface of the first waveguide.

20. The near-eye display system of claim 15, wherein:
at least one of the first pupil expander or the second pupil expander is flexible; and
the near-eye display system includes one or more actuators configured to bend at least one of the first pupil expander or the second pupil expander.
